(19) United States
(12) Patent Application Publication
(10) Pub. No.: US 2025/0369405 A1
(43) Pub. Date: Dec. 4, 2025

(54) CONTROLLER FOR INTERNAL COMBUSTION ENGINE

(71) Applicant: TOYOTA JIDOSHA KABUSHIKI KAISHA, Toyota-shi (JP)

(72) Inventors: Tatsunobu HATTORI, Seto-shi (JP); Yutaro KITANO, Toyota-shi (JP); Ryota IWASAKI, Okazaki-shi (JP)

(21) Appl. No.: 19/183,928

(22) Filed: Apr. 21, 2025

(30) Foreign Application Priority Data
Jun. 4, 2024 (JP) 2024-090701

(51) Int. Cl. F02D 41/38; F02D 41/00; F02D 41/22; F02D 41/30

(52) U.S. Cl. CPC F02D 41/38; F02D 41/0027; F02D 41/221; F02D 41/3005; F02D 2041/224; F02D 2200/0602; F02D 2200/501

(57) ABSTRACT

A controller is configured to control an internal combustion engine mounted on a vehicle. The controller includes processing circuitry. The processing circuitry outputs a valve closing signal to a shut-off valve, and executes, when a stopping operation of the internal combustion engine is performed, a determination process of determining whether the shut-off valve is stuck open based on a decrease amount of a passage fuel pressure. The controller does not execute the determination process when at least one of a condition that a vehicle speed is higher than a first determination speed and a condition that an engine rotation speed is higher than or equal to a second determination speed is met.

### CROSS-REFERENCE TO RELATED APPLICATIONS

This application is based upon and claims the benefit of priority from Japanese Patent Application No. 2024-90701, filed on Jun. 4, 2024, the entire contents of which are incorporated herein by reference.

### BACKGROUND

### 1. Field

The present disclosure relates to a controller for an internal combustion engine.

### 2. Description of Related Art

Japanese Laid-Open Patent Publication No. 2001-041106 discloses an internal combustion engine that uses gaseous fuel. A shut-off valve is disposed in a fuel passage of the internal combustion engine. While the internal combustion engine is in a stopped state, the shut-off valve is closed, thereby stopping the supply of fuel from the fuel tank to the fuel injection valves.

One method of determining whether the shut-off valve is stuck open involves issuing a closing command to the shut-off valve during fuel injection and then monitoring changes in the fuel pressure between the shut-off valve and the fuel injection valves in the fuel passage (hereinafter, referred to as “passage fuel pressure”). If the shut-off valve is closed, the amount of fuel in the fuel passage decreases as the fuel injection is performed, and thus the passage fuel pressure decreases. If the shut-off valve is stuck open, fuel continues to be supplied from the fuel tank to the fuel injection valves. As a result, even during fuel injection, the passage fuel pressure is unlikely decrease. Therefore, a determination can be made that the shut-off valve is stuck open based on a small decrease in the passage fuel pressure.

Since the determination of whether the shut-off valve is stuck open involves closing the shut-off valve, it is preferable to execute this determination after the user has performed a stopping operation of the internal combustion engine. However, even after the stopping operation of the internal combustion engine is performed, the internal combustion engine continues to operate until the determination of whether the shut-off valve is stuck open is complete. In some cases, it is desirable to stop the internal combustion engine immediately after the stopping operation of the internal combustion engine is performed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a controller for an internal combustion engine is configured to control an internal combustion engine mounted on a vehicle. The internal combustion engine includes a fuel tank storing gaseous fuel, a fuel injection valve supplying the fuel into a cylinder, a fuel passage connecting the fuel tank to the fuel injection valve, a shut-off valve disposed in the fuel passage, and a pressure sensor disposed in a portion of the fuel passage between the shut-off valve and the fuel injection valve and configured to detect a passage fuel pressure that is a pressure of the fuel in the portion. The controller includes processing circuitry. The processing circuitry is configured to output a valve closing signal to the shut-off valve, execute, when a stopping operation of the internal combustion engine is performed, a determination process of determining whether the shut-off valve is stuck open based on a decrease amount of the passage fuel pressure that occurs until an elapsed period after the valve closing signal is output reaches a predetermined specified period, and not execute the determination process when at least one of a condition that a vehicle speed is higher than a first determination speed and a condition that an engine rotation speed is higher than or equal to a second determination speed is met.

The above-described controller for the internal combustion engine enables the internal combustion engine to be promptly stopped after a stopping operation of the internal combustion engine is performed in situations where stopping the engine is desirable.

Other features and aspects will be apparent from the following detailed description, the drawings, and the claims.

### BRIEF DESCRIPTION OF THE DRAWINGS

FIG. 1 is a schematic diagram showing an internal combustion engine and a controller for the internal combustion engine according to an embodiment.

FIG. 2 is a flowchart showing a procedure of a determination process executed by the controller of the embodiment.

FIG. 3 is a flowchart showing a procedure of a process of determining whether or not to execute the determination process executed by the controller of the embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### Embodiment

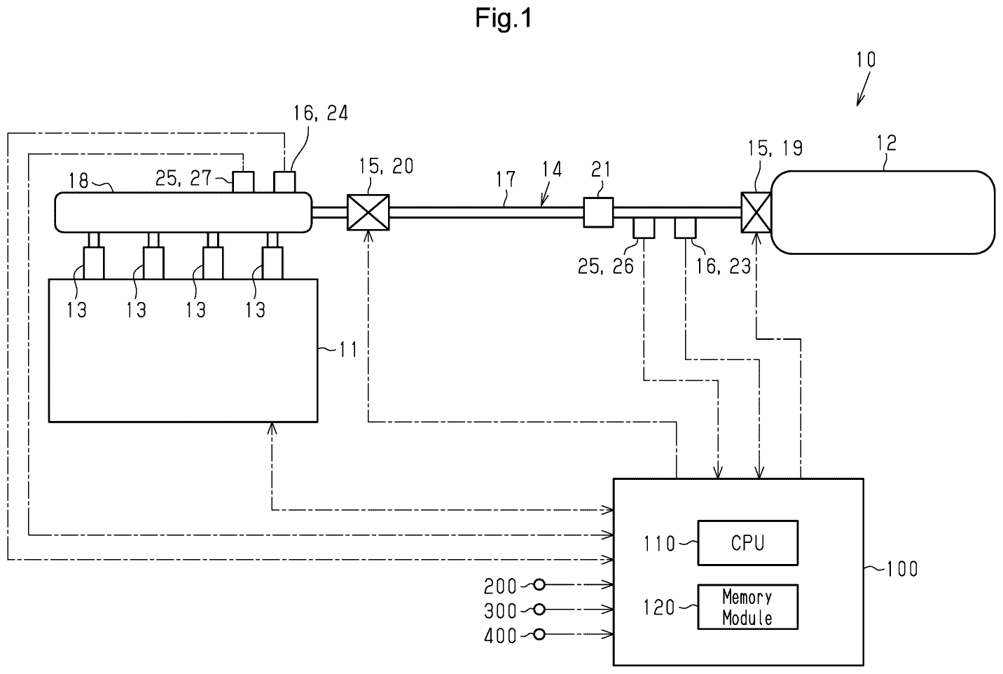

Hereinafter, an embodiment of a controller for an internal combustion engine will be described with reference to FIGS. 1 to 3.

### Configuration of Internal Combustion Engine and Controller for Internal Combustion Engine

FIG. 1 shows an internal combustion engine 10 mounted on a vehicle. The fuel of the internal combustion engine 10 is gaseous fuel. An example of a gaseous fuel is hydrogen gas.

The internal combustion engine 10 includes an engine body 11. The engine body 11 burns fuel injected from the plurality of fuel injection valves 13 inside the corresponding cylinders to thereby generate power for making the vehicle travel. In FIG. 1, members such as a cylinder and an ignition plug are omitted.

The internal combustion engine 10 includes a fuel tank 12, a plurality of fuel injection valves 13, a fuel passage 14, a shut-off valve 15, and a pressure sensor 16. The fuel tank 12 stores a gaseous fuel. Gaseous fuel is stored in the fuel tank 12 in a compressed state. Gaseous fuel is supplied from the fuel tank 12 to the fuel injection valve 13. The fuel injection valve 13 supplies fuel into the corresponding cylinder.

The fuel passage 14 connects the fuel tank 12 and the fuel injection valve 13. The fuel passage 14 is constituted by a fuel pipe 17 connected to the fuel tank 12 and a delivery pipe 18 connecting the fuel pipe 17 and the fuel injection valve 13. The fuel stored in the fuel tank 12 is supplied to the fuel injection valve 13 via a fuel pipe 17 and a delivery pipe 18.

The shut-off valves 15 are disposed in the fuel passage 14. The shut-off valves 15 are, for example, electromagnetic valves. The shut-off valves 15 are switched between a valve open state and a valve closed state by the controller 100. When the shut-off valves 15 receive a valve opening command from the controller 100, the shut-off valves 15 are opened. When the shut-off valves 15 receive a valve closing command from the controller 100, the shut-off valves 15 are closed. Specifically, when a valve opening command is input from the controller 100 to the drive circuits of the shut-off valves 15, the drive circuits supply electric power to the shut-off valves 15. As a result, the shut-off valves 15 are opened. When a valve closing command is input from the controller 100 to the drive circuits of the shut-off valves 15, the drive circuits stop the supply of electric power to the shut-off valves 15. As a result, the shut-off valves 15 are closed. The shut-off valves 15 are maintained in an open state during operation of the internal combustion engine 10. The shut-off valves 15 are maintained in a closed state while the operation of the internal combustion engine 10 is in a stopped state. The shut-off valves 15 include a first shut-off valve 19 and a second shut-off valve 20.

The first shut-off valve 19 is disposed in the fuel passage 14 in the vicinity of the outlet of the fuel tank 12. The first shut-off valve 19 is disposed at an end portion of the fuel pipe 17 on the fuel tank 12 side. When the first shut-off valve 19 is in an open state, fuel is supplied from the fuel tank 12 to the fuel pipe 17. When the first shut-off valve 19 is in the closed state, the fuel supply from the fuel tank 12 to the fuel pipe 17 is stopped.

The second shut-off valve 20 is disposed downstream of the first shut-off valve 19 in the fuel passage 14. The second shut-off valve 20 is disposed in the vicinity of the delivery pipe 18. The second shut-off valve 20 is disposed between the fuel pipe 17 and the delivery pipe 18. When the second shut-off valve 20 is open, fuel is supplied from the fuel pipe 17 to the delivery pipe 18. When the second shut-off valve 20 is in the closed state, the fuel supply from the fuel pipe 17 to the delivery pipe 18 is stopped.

A pressure reducing valve 21 is disposed in the fuel passage 14 between the first shut-off valve 19 and the second shut-off valve 20. The pressure reducing valve 21 regulates the pressure of the fuel flowing into the delivery pipe 18 from the high-pressure fuel tank 12.

The pressure sensor 16 is disposed in a portion of the fuel passage 14 between the shut-off valve 15 and the fuel injection valve 13. The pressure sensor 16 detects a passage fuel pressure that is a pressure of the fuel in a portion between the shut-off valve 15 and the fuel injection valve 13. The pressure sensor 16 outputs a detection signal regarding the detected passage fuel pressure to the controller 100.

The pressure sensor 16 includes a first pressure sensor 23 and a second pressure sensor 24. The first pressure sensor 23 is arranged between the first shut-off valve 19 and the fuel injection valve 13 in the fuel passage 14. The first pressure sensor 23 is disposed between the first shut-off valve 19 and the second shut-off valve 20 in the fuel passage 14. The first pressure sensor 23 detects a first passage fuel pressure that indicates a passage fuel pressure between the first shut-off valve 19 and the fuel injection valve 13. The second pressure sensor 24 is arranged between the second shut-off valve 20 and the fuel injection valve 13. The second pressure sensor 24 detects a second passage fuel pressure that indicates a passage fuel pressure between the second shut-off valve 20 and the fuel injection valve 13. The internal combustion engine 10 includes a temperature sensor 25. The temperature sensor 25 is disposed in a portion of the fuel passage 14 between the shut-off valve 15 and the fuel injection valve 13. The temperature sensor 25 detects a passage fuel temperature which is a temperature of the fuel in a portion between the shut-off valve 15 and the fuel injection valve 13. The temperature sensor 25 outputs a detection signal regarding the detected passage fuel temperature to the controller 100.

The temperature sensor 25 includes a first temperature sensor 26 and a second temperature sensor 27. The first temperature sensor 26 is disposed between the first shut-off valve 19 and the fuel injection valve 13. The first temperature sensor 26 is disposed between the first shut-off valve 19 and the second shut-off valve 20. The second temperature sensor 27 is arranged between the second shut-off valve 20 and the fuel injection valves 13.

The controller 100 performs various controls of the internal combustion engine 10 by controlling various control targets such as the fuel injection valve 13, the first shut-off valve 19, the second shut-off valve 20, and the pressure reducing valve 21. For example, the controller 100 drives the shut-off valve 15 to open by transmitting a valve opening signal to the shut-off valve 15, and drives the shut-off valve 15 to close by transmitting a valve closing signal to the shut-off valve 15.

The controller 100 includes a CPU 110 and a memory module 120 including a ROM, a RAM, and the like. When the CPU 110 executes the program stored in the memory module 120, various controls are performed by the controller 100. The CPU 110 corresponds to processing circuitry.

The controller 100 acquires various values necessary for controlling the internal combustion engine 10. For example, the controller 100 acquires detection signals of the pressure sensor 16 and the temperature sensor 25. In addition, the controller 100 acquires detection signals of various sensors such as an accelerator operation amount sensor 200, a vehicle speed sensor 300, and an ignition sensor 400. The accelerator operation amount sensor 200 detects an accelerator opening degree that is an operation amount of an accelerator pedal operated by a user of the vehicle on which the internal combustion engine 10 is mounted. The vehicle speed sensor 300 detects a vehicle speed of the vehicle on which the internal combustion engine 10 is mounted. The controller 100 acquires, from the internal combustion engine 10, signals such as a detection signal for calculating an engine rotation speed of the internal combustion engine 10 and a detection signal of an intake air amount.

### Determination Process

The controller 100 outputs a valve closing signal to the shut-off valve 15, and determines the open fixation of the shut-off valve 15 on the basis of a reduction amount of the passage fuel pressure generated until an elapsed period after outputting the valve closing signal reaches a predetermined specified period. During execution of the determination process, the fuel injection valve 13 executes fuel injection. During execution of the determination process, fuel continues to be supplied from the fuel injection valve 13 into the cylinder. The controller 100 stores a determination result indicating that the shut-off valve 15 is stuck open in the memory module 120 when the amount of decrease in the passage fuel pressure that occurs until the elapsed period after the valve closing signal is output reaches a predetermined specified period is smaller than a specified threshold. The specified threshold is set, for example, based on the amount of fuel consumed during the idle operation of the internal combustion engine 10. The amount of fuel consumed during the idle operation of the internal combustion engine 10 is obtained based on the number of times of fuel injection performed during the idle operation, the injection time, and the passage fuel temperature.

The controller 100 may set the specified threshold in accordance with the passage fuel pressure, the passage fuel temperature, or the like at the start of the determination process. The controller 100 sets a larger specified threshold as the passage fuel temperature at the start of the determination process is higher.

The determination process includes a first determination process of determining whether the first shut-off valve 19 is stuck open and a second determination process of determining whether the second shut-off valve 20 is stuck open.

The first determination process will be described. During the execution of the first determination process, the second shut-off valve 20 is in the open state.

When the first shut-off valve 19 is closed, the supply of fuel from the fuel tank 12 to the fuel passage 14 is stopped. Although the fuel is supplied from the fuel injection valve 13 into the cylinder by the fuel injection of the fuel injection valve 13, since the fuel supply from the fuel tank 12 to the fuel passage 14 is stopped, the first passage fuel pressure decreases. On the other hand, when the first shut-off valve 19 is stuck open, the supply of fuel from the fuel tank 12 to the fuel passage 14 continues, so the first passage fuel pressure does not drop, or the amount of drop in the first passage fuel pressure becomes smaller than when the first shut-off valve 19 is in the closed state. Therefore, it is possible to determine that the first shut-off valve 19 is stuck open based on the amount of decrease in the first passage fuel pressure.

The second determination process will be described. During the execution of the second determination process, the first shut-off valve 19 is preferably in the closed state.

When the second shut-off valve 20 is closed, the supply of fuel from the fuel pipe 17 to the delivery pipe 18 is stopped. Although the fuel is supplied from the fuel injection valve 13 into the cylinder by the fuel injection of the fuel injection valve 13, since the fuel supply from the fuel pipe 17 to the delivery pipe 18 is stopped, the second passage fuel pressure decreases. On the other hand, when the second shut-off valve 20 is stuck open, the supply of fuel from the fuel pipe 17 to the delivery pipe 18 continues, so the second passage fuel pressure does not drop, or the amount of drop in the second passage fuel pressure is smaller than when the second shut-off valve 20 is in the closed state. Therefore, it is possible to determine that the second shut-off valve 20 is stuck open based on the amount of decrease in the second passage fuel pressure.

The controller 100 executes the determination process when the stopping operation of the internal combustion engine 10 is performed. The stopping operation of the internal combustion engine 10 is, for example, turning off an ignition switch by a user of the vehicle. In a case in which the stopping operation of the internal combustion engine 10 is executed, the controller 100 starts the determination process and continues the operation of the internal combustion engine 10 until the determination process ends. When the stopping operation of the internal combustion engine 10 is executed, the controller 100 stops the internal combustion engine 10 after executing the determination process.

### Flow of Determination Process

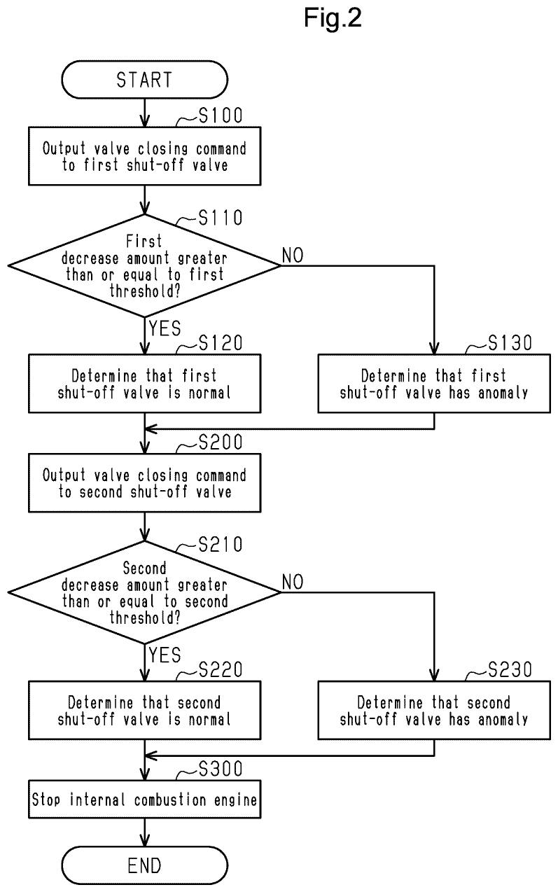

FIG. 2 shows a flow of a series of processes related to the determination process executed by the controller 100. The controller 100 executes a series of processes of FIG. 2 in the determination process.

The controller 100 outputs a valve-closing command to the first shut-off valve 19 (S100). The controller 100 determines whether or not a first decrease amount is equal to or greater than the first threshold (S110). The first decrease amount is a decrease amount of the first passage fuel pressure after the first period has elapsed since the valve-closing command was output to the first shut-off valve 19 in S100. The first threshold is set, for example, based on the amount of fuel consumed during the first period. The first period is, for example, 2 seconds.

When the first amount of decrease is equal to or greater than the first threshold (S110: YES), the controller 100 stores the determination result indicating that the first shut-off valve 19 is normal without being stuck open in the memory module 120 (S120), and proceeds to the process of S200. When the first decrease amount is less than the first threshold (S110: NO), the controller 100 stores the determination result indicating the anomaly in which the first shut-off valve 19 is stuck open in the memory module 120 (S130), and proceeds to the process of S200. The process from S100 to S130 corresponds to a first determination process.

The controller 100 outputs a valve-closing command to the second shut-off valve 20 (S200). The controller 100 determines whether or not a second decrease amount is equal to or larger than the second threshold (S210). The second decrease amount is a decrease amount of the second passage fuel pressure after the second period has elapsed since the valve-closing command was output to the second shut-off valve 20 in S200. The second threshold is set based on the amount of fuel consumed while the second period elapses. The second period may be the same as the first period.

When the second decrease amount is equal to or larger than the second threshold (S210: YES), the controller 100 stores the determination result indicating that the second shut-off valve 20 is normal without being stuck open in the memory module 120 (S220), and proceeds to the process of S300. When the second decrease amount is less than the second threshold (S210: NO), the controller 100 stores the determination result indicating the anomaly in which the second shut-off valve 20 is stuck open in the memory module 120 (S230), and proceeds to the process of S300. The process from S200 to S230 corresponds to a second determination process.

The controller 100 stops the internal combustion engine 10 (S300), and ends the processing of FIG. 2. The controller 100 may output the determination results of the first shut-off valve 19 and the second shut-off valve 20 to a user or the like of the vehicle.

When the determination process is not executed

In the case in which the determination process is executed after the stopping operation of the internal combustion engine 10, the operation of the internal combustion engine 10 cannot be stopped until the determination process ends. Therefore, when the user of the vehicle wants to quickly stop the operation of the internal combustion engine 10, the stop of the internal combustion engine 10 is delayed by the execution of the determination process. The situation in which the stop of the internal combustion engine 10 is prioritized over the execution of the determination process includes, for example, an anomaly such as a vehicle accident, a vehicle fire, smoke generation, occurrence of abnormal noise, and occurrence of odor. When an anomaly as described above occurs while the vehicle is traveling, the user of the vehicle attempts to stop the internal combustion engine 10. In a situation where the stop of the internal combustion engine 10 is prioritized over the execution of the determination process as described above, it is required to quickly stop the internal combustion engine 10.

The controller 100 determines whether the determination process can be executed based on at least one of the vehicle speed and the engine rotation speed. The controller 100 does not execute the determination process in at least one of a case in which the vehicle speed is higher than a first determination speed and a case in which the engine rotation speed is higher than or equal to a second determination speed. In other words, the controller 100 prohibits execution of the determination process in at least one of a case in which the vehicle speed is higher than the first determination speed and a case in which the engine rotation speed is higher than or equal to the second determination speed. The first determination speed and the second determination speed are set to speeds corresponding to the above-described anomaly. When the stopping operation of the internal combustion engine 10 is executed, if at least one of the vehicle speed being higher than the first determination speed and the engine rotation speed being higher than or equal to the second determination speed is satisfied, the controller 100 outputs the valve closing command to the shut-off valve 15 without executing the determination process, and then stops the fuel injection by the fuel injection valve 13 and the ignition of the fuel by the ignition plug to stop the internal combustion engine 10.

As the first determination speed, a speed at which it can be determined that the vehicle is traveling is set. The first determination speed is, for example, 0 km/h. Preferably, the controller 100 does not execute the determination process when the vehicle speed is higher than the first determination speed. When the car speed is higher than 0 km/h which is the first determination speed, the car is running. When the stopping operation of the internal combustion engine 10 is executed during the traveling of the vehicle, there is a high possibility that the stopping operation of the internal combustion engine 10 is associated with the occurrence of an anomaly.

For example, a speed at which it can be determined that the engine rotation speed of the internal combustion engine 10 is higher than or equal to a specified speed is set as the second determination speed. The engine rotation speed is the number of revolutions per unit time of the output shaft of the internal combustion engine 10. The specified engine rotation speed is, for example, 3000 rpm. In a case in which the engine rotation speed of the internal combustion engine 10 is higher than or equal to the 3000 rpm while the user is performing the stopping operation of the internal combustion engine 10, there is a possibility that an anomaly has occurred in the internal combustion engine 10. In a situation where the stopping operation of the internal combustion engine 10 is executed in a state where the engine rotation speed of the internal combustion engine 10 is higher than or equal to the 3000 rpm, it is desirable to quickly stop the internal combustion engine 10.

Preferably, the controller 100 does not execute the determination process when the vehicle speed is equal to or lower than a first determination speed and the engine rotation speed is higher than or equal to a second determination speed. When the car speed is equal to or lower than 0 km/h, which is the first determination speed, the car is stopped. In a case in which the stopping operation of the internal combustion engine 10 is executed in a situation where the engine rotation speed is higher than or equal to the second determination speed while the vehicle is stopped, there is a high possibility that the stopping operation of the internal combustion engine 10 is associated with the occurrence of an anomaly.

### Flow of Determination Process

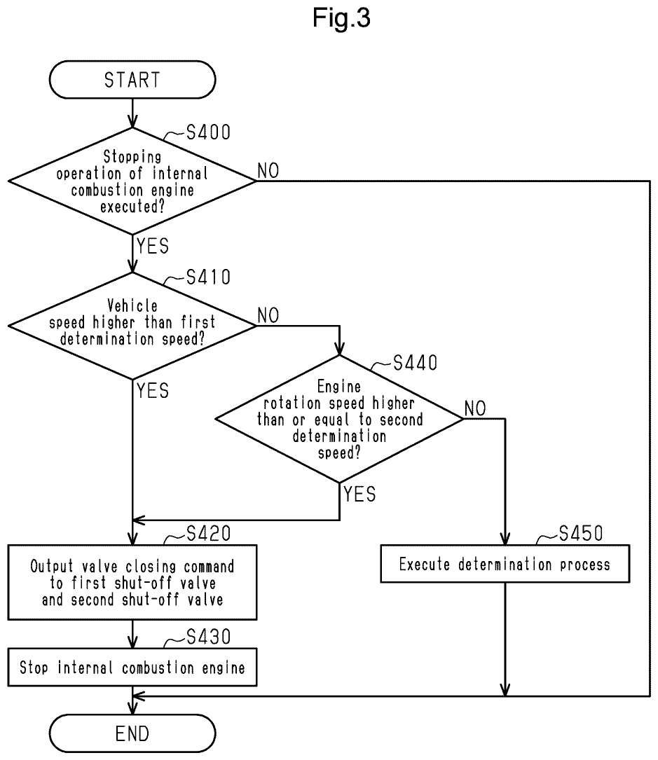

FIG. 3 shows a flow of a series of processes for determining whether or not to execute the determination process executed by the controller 100. The controller 100 repeatedly executes the processing of FIG. 3.

The controller 100 determines whether or not the stopping operation of the internal combustion engine 10 is executed (S400). When the stopping operation of the internal combustion engine 10 has not been executed (S400: NO), the controller 100 ends the processing of FIG. 3.

When the stopping operation of the internal combustion engine 10 is executed (S400: YES), the controller 100 determines whether or not the vehicle speed is higher than the first determination speed (S410). When the vehicle speed is higher than the first determination speed (S410: YES), the controller 100 outputs the valve-closing command to the first and second shut-off valves 19 and 20 (S420), then stops the internal combustion engine 10 (S430), and ends the processing of FIG. 3 without executing the determination process.

When the vehicle speed is not higher than the first determination speed (S410: NO), the controller 100 determines whether the engine rotation speed is higher than or equal to a second determination speed (S440). When the engine rotation speed is higher than or equal to the second determination speed (S440: YES), the controller 100 outputs the valve-closing command to the first and second shut-off valves 19 and 20 (S420), then stops the internal combustion engine 10 (S430), and ends the processing of FIG. 3 without executing the determination process.

If the engine rotation speed is not higher than or equal to the second determination speed (S440: NO), the controller 100 executes the determination process (S450), and ends the process of FIG. 3. The determination process executed in S450 is a series of processes shown in FIG. 2.

### Operation and Advantages of Present Embodiment

(1) As a situation where it is desirable to quickly stop the internal combustion engine 10, there is a case in which the user of the vehicle performs the stopping operation of the internal combustion engine 10 when the vehicle speed of the vehicle on which the internal combustion engine 10 is mounted is higher than a first determination speed or when the engine rotation speed is higher than or equal to a second determination speed. In a situation in which it is desirable to stop the internal combustion engine 10, the controller 100 prioritizes the stop of the internal combustion engine 10 over the determination process. Therefore, the controller 100 can stop the internal combustion engine 10 immediately after the stopping operation of the internal combustion engine 10 in a situation in which it is desirable to stop the internal combustion engine 10.

(2) In a situation where the stopping operation of the internal combustion engine 10 is executed while the vehicle is traveling, it is desirable to stop the internal combustion engine 10 at an early stage. In the above-described controller 100, when the stopping operation of the internal combustion engine 10 is executed, the determination process is not executed if the vehicle speed is higher than 0 km/h. In this way, the controller 100 can more suitably determine a situation in which it is desirable to quickly stop the internal combustion engine 10 based on the vehicle speed.

(3) In a situation where the stopping operation of the internal combustion engine 10 is executed in a state where the engine rotation speed of the internal combustion engine 10 is very high, it is desirable to stop the internal combustion engine 10 at an early stage. In the controller 100 described above, when the stopping operation of the internal combustion engine 10 is executed, the determination process is not executed if the engine rotational speed is higher than or equal to the second determination speed. In this way, the controller 100 can more suitably determine a situation in which it is desirable to quickly stop the internal combustion engine 10 based on the engine rotational speed.

### Modifications

The above-described embodiment may be modified as follows. The above-described embodiment and the following modifications can be combined as long as the combined modifications remain technically consistent with each other.

The internal combustion engine 10 may be configured to include only one of the first shut-off valve 19 and the second shut-off valve 20 as the shut-off valve.

When the controller 100 executes the determination process, only one of the first determination process and the second determination process may be executed as the determination process.

In a case in which the stopping operation of the internal combustion engine 10 is executed, when the vehicle speed is equal to or lower than the first determination speed, the determination process may be executed regardless of the engine rotation speed.

In the embodiment, the example in which the possibility of the execution of the determination process is determined based on both the vehicle speed and the engine rotation speed has been described, but the possibility of the execution of the determination process may be determined based on any one of the vehicle speed and the engine rotation speed. When the engine rotation speed is higher than or equal to the second determination speed in a case in which the stopping operation of the internal combustion engine 10 is executed while the vehicle is stopped, for example, there is a possibility that an anomaly occurs in the internal combustion engine 10. On the other hand, in a case in which the stopping operation of the internal combustion engine 10 is executed while the vehicle is traveling, if the engine rotational speed is higher than or equal to the second determination speed, the user may fall into panic due to occurrence of an anomaly and continue to depress the accelerator pedal.

The controller 100 is not limited to a device that includes a CPU and a memory module and executes software processing. For example, the controller 100 may include a dedicated hardware circuit, such as an application specific integrated circuit (ASIC), that performs hardware processing on at least a part of the software processing in the above-described embodiment. That is, the controller 100 may be modified as long as it includes processing circuitry that has any one of the following configurations (a) to (c). (a) Processing circuitry including at least one processor that executes all of the above-described processes according to programs and at least one program storage device such as a ROM that stores the programs. (b) Processing circuitry including at least one processor and at least one program storage device that execute part of the above-described processes according to the programs and at least one dedicated hardware circuit that executes the remaining processes. (c) Processing circuitry including at least dedicated hardware circuit that executes all of the above-described processes. The program storage device, which is a computer-readable medium, includes any type of medium that is accessible by a general-purpose computer or a dedicated computer.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuitry are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A controller for an internal combustion engine, the controller being configured to control an internal combustion engine mounted on a vehicle, the internal combustion engine including a fuel tank storing gaseous fuel, a fuel injection valve supplying the fuel into a cylinder, a fuel passage connecting the fuel tank to the fuel injection valve, a shut-off valve disposed in the fuel passage, and a pressure sensor disposed in a portion of the fuel passage between the shut-off valve and the fuel injection valve and configured to detect a passage fuel pressure that is a pressure of the fuel in the portion, the controller comprising processing circuitry, wherein
the processing circuitry is configured to
output a valve closing signal to the shut-off valve,
execute, when a stopping operation of the internal combustion engine is performed, a determination process of determining whether the shut-off valve is stuck open based on a decrease amount of the passage fuel pressure that occurs until an elapsed period after the valve closing signal is output reaches a predetermined specified period, and
not execute the determination process when at least one of a condition that a vehicle speed is higher than a first determination speed and a condition that an engine rotation speed is higher than or equal to a second determination speed is met.
